(19) United States
(12) Patent Application Publication
(10) Pub. No.: US 2007/0055921 A1
(43) Pub. Date: Mar. 8, 2007

(54) Document editing system

(76) Inventor: Timothy W. Challenor, London (GB)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/215,735

(22) Filed: Aug. 30, 2005

(51) Int. Cl. G06F 17/00; G06F 17/30

(52) U.S. Cl. 715/500; 715/530; 707/1

(57) ABSTRACT

An editing system is provided, the system comprising a control file store for storing control file data; a control file manager capable of selectively obtaining content data from a data resource in response to a search term input by a user, generating control file data on the basis of the obtained content data and storing the control file data in the control file store; a document verifier capable of receiving document data forming part of a document edited by a user and outputting a control signal based on the document data and part or all of the control file data; and a document controller capable of receiving control signals from the document verifier and performing a predetermined action at least in response to receiving a rejection control signal. The system provides control over the content of a document edited by a user.

The invention is in the field of document editing systems.

Various computer implemented systems for creating and editing multimedia documents exist in the art. For example, word processing and desktop publishing packages are commonly used to create and edit documents consisting of text and images. Video editing software is also widely used. A document in this context may be any collection of media content, including any one or more of text, images, video and sound.

These prior art systems accept input of content either from a user, in the case of a word processor for example, or from an external device, for example a video camera in the case of a video editing system. The user can then manipulate the content as desired within the capabilities of the system.

Particularly in commercial use of such editing systems, it is often important that the content of a document falls within certain guidelines. Prior art editing systems do not provide sufficiently sophisticated means for checking that the content of a document is acceptable for the intended purpose, increasing the likelihood that a mistake in editing a document will result in the final document containing unsuitable content.

In accordance with a first aspect of the present invention, there is provided an editing system comprising: a control file store for storing control file data; a control file manager capable of selectively obtaining content data from a data resource in response to a search term input by a user, generating control file data on the basis of the obtained content data and storing the control file data in the control file store; a document verifier capable of receiving document data forming part of a document edited by a user and outputting a control signal based on the document data and part or all of the control file data; and a document controller capable of receiving the control signal and performing a predetermined action in response to receiving a rejection control signal.

Preferably, the editing system further comprises: a configuration file store for storing configuration file data; and a rule manager capable of receiving commands input by a user, the commands defining one or more rules for use of the control file data, and further capable of generating configuration file data defining the rules in response to the commands and storing the configuration file data in the configuration file store; wherein the document verifier is capable of outputting the control signal based on the document data, part or all of the control file data and part or all of the configuration file data.

The editing system according to the invention is thus capable of ensuring that the document resulting from the editing process uses only appropriate content and complies with a predetermined set of rules. The control file data on the basis of which the content of the document is verified can be determined on the basis of search terms input by a user, by obtaining selected data from one or more data resources. Hence, a set of control file data suitable for a particular context can be obtained quickly and conveniently by inputting an appropriate search term.

Preferably, the document verifier outputs an acceptance control signal if the document data is contained in the control file data and complies with the rules contained in the configuration file data.

Suitably, the document verifier outputs the rejection control signal if the document data is not contained in the control file data and also outputs the rejection control signal if the document data does not comply with a rule contained in the configuration file data.

Preferably, the editing system further comprises a document store capable of storing the document data; wherein the document controller comprises a storage controller for preventing storage of the document data in the document store in response to the rejection control signal. Conveniently, the document controller comprises a user informer for notifying the user that the document data has been rejected in response to the rejection control signal.

Suitably, the document controller comprises a document data replacer for deleting the document data and replacing it with alternative document data in response to the rejection control signal.

Preferably, the editing system further comprises a statistics display for displaying statistics related to the document data to the user, the statistics being updated during editing.

In one embodiment, the content data consists of a plurality of content data objects and the rule manager is capable of determining an association between two or more of the plurality of content data objects on the basis of the relative arrangement of the content data objects within the content data; wherein the rule manager is capable of generating a deduced rule defining the determined association, generating deduced configuration file data defining the deduced rule and storing the deduced configuration file data in the configuration file store.

Preferably, the editing system further comprises an authoriser for authorising a user upon activation of the editing system, wherein the authoriser is capable of requesting login data to be input by a user; wherein if the login data input by the user is contained within a first file then the authoriser allows the user to operate at least one of the control file manager and the rule manager; wherein if the login data input by the user is contained within a second file then the authoriser allows the user to operate the document verifier and the document controller and does not allow the user to operate the control file manager or the rule manager; and wherein if the login data input by the user is not contained within the first file and is not contained within the second file then the authoriser does not allow the user to operate any of the control file manager, the rule manager, the document verifier and the document controller.

Suitably, the control file manager further comprises a communicator for outputting the search term to a helper application via a network and receiving information from the helper application via the network, wherein the helper application is capable of retrieving selected information from the data resource in response to the search term and outputting the selected information to the communicator via the network.

Conveniently, the editing system further comprises a file assignor capable of assigning a subset of the control file data to a user and further capable of assigning a subset of the configuration file data to the user; wherein when the document verifier receives document data forming part of a document edited by the user, the document verifier outputs the control signal based on the document data, the subset of the control file data and the subset of the configuration file data.

In a second aspect of the present invention, there is provided a method for controlling an editing system, the method comprising: selectively obtaining content data from a data resource in response to a search term input by a user, generating control file data on the basis of the obtained content data and storing the control file data in a control file store;
receiving commands input by a user, the commands defining one or more rules for use of the control file data, generating configuration file data defining the rules in response to the commands and storing the configuration file data in a configuration file store;
receiving document data forming part of a document edited by a user and determining whether the document data is allowable based on the document data, part or all of the control file data and part or all of the configuration file data; and performing a predetermined action if the document data is determined not to be allowable.

In a third aspect of the present invention, there is provided a computer program product capable of performing a method for controlling an editing system, the method comprising: selectively obtaining content data from a data resource in response to a search term input by a user, generating control file data on the basis of the obtained content data and storing the control file data in a control file store; receiving commands input by a user, the commands defining one or more rules for use of the control file data, generating configuration file data defining the rules in response to the commands and storing the configuration file data in a configuration file store; receiving document data forming part of a document edited by a user and determining whether the document data is allowable based on the document data, part or all of the control file data and part or all of the configuration file data; and performing a predetermined action if the document data is determined not to be allowable.

In a fourth aspect of the present invention, there is provided an editing system comprising: a control file store for storing control file data including one or more data objects; a configuration file store for storing configuration file data defining one or more rules; a document verifier capable of receiving document data including one or more document data objects forming part of a document edited by a user and outputting a control signal based on whether the document data objects are included in the control file data and whether the document data complies with the rules defined in the configuration file data; a document store for storing the document; and a document controller capable of receiving the control signal and preventing the document from being stored in the document store in response to receiving the rejection control signal.

Embodiments of the present invention will now be described by way of further example only and with reference to the accompanying drawings, in which:

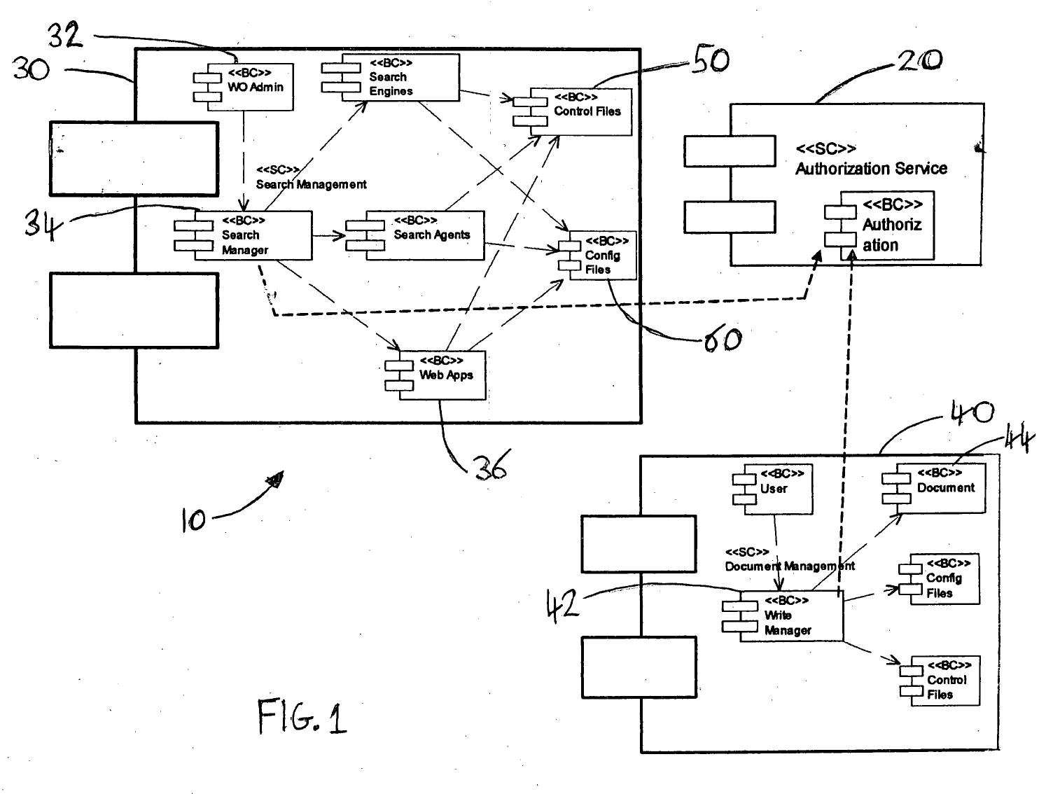

FIG. 1 is a schematic diagram showing the structure of an editing system according to an embodiment of the invention.

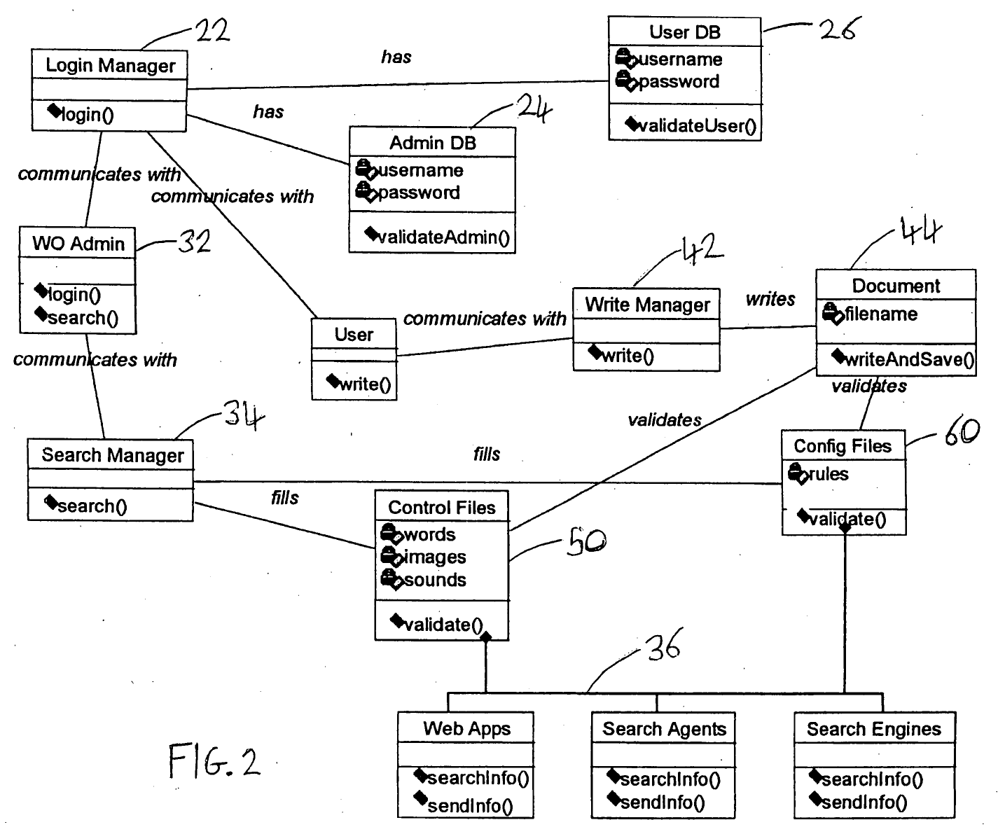

FIG. 2 shows an arrangement of program modules in a computer program implementing an embodiment of the invention.

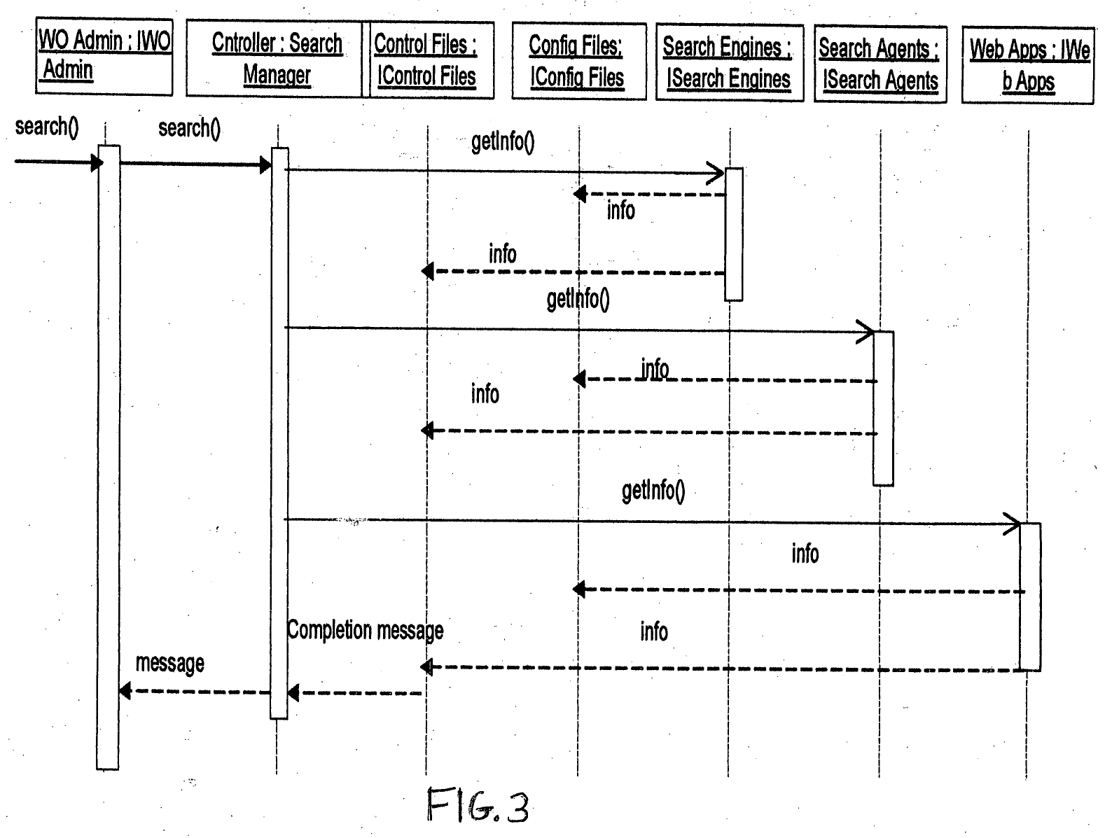

FIG. 3 shows the operation of the administration system to fill control and configuration files.

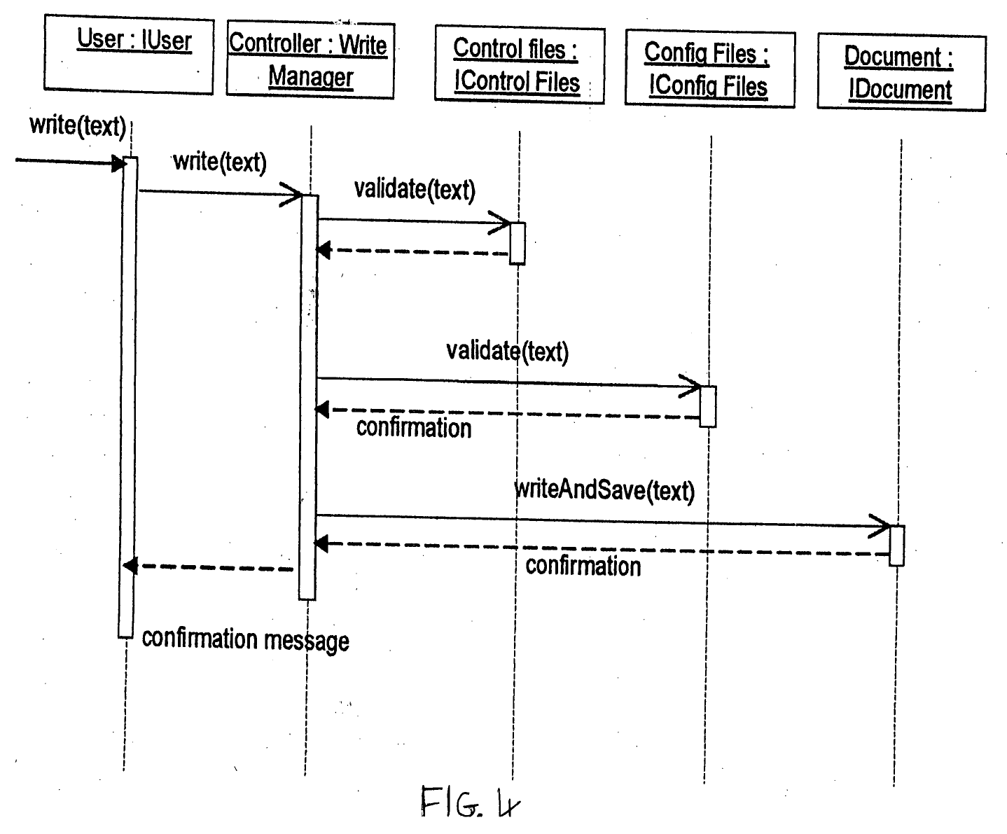

FIG. 4 shows the operation of the document control system to control editing of a document.

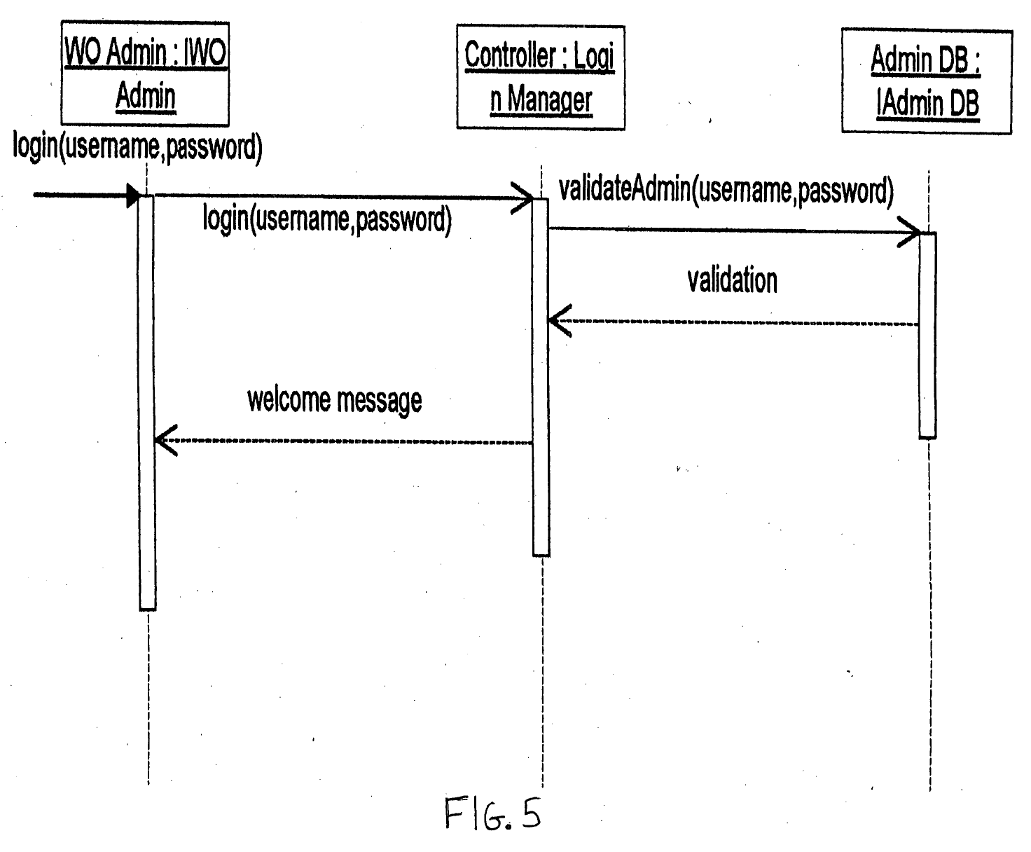

FIG. 5 shows the operation of the authorisation system to authorise an administrator.

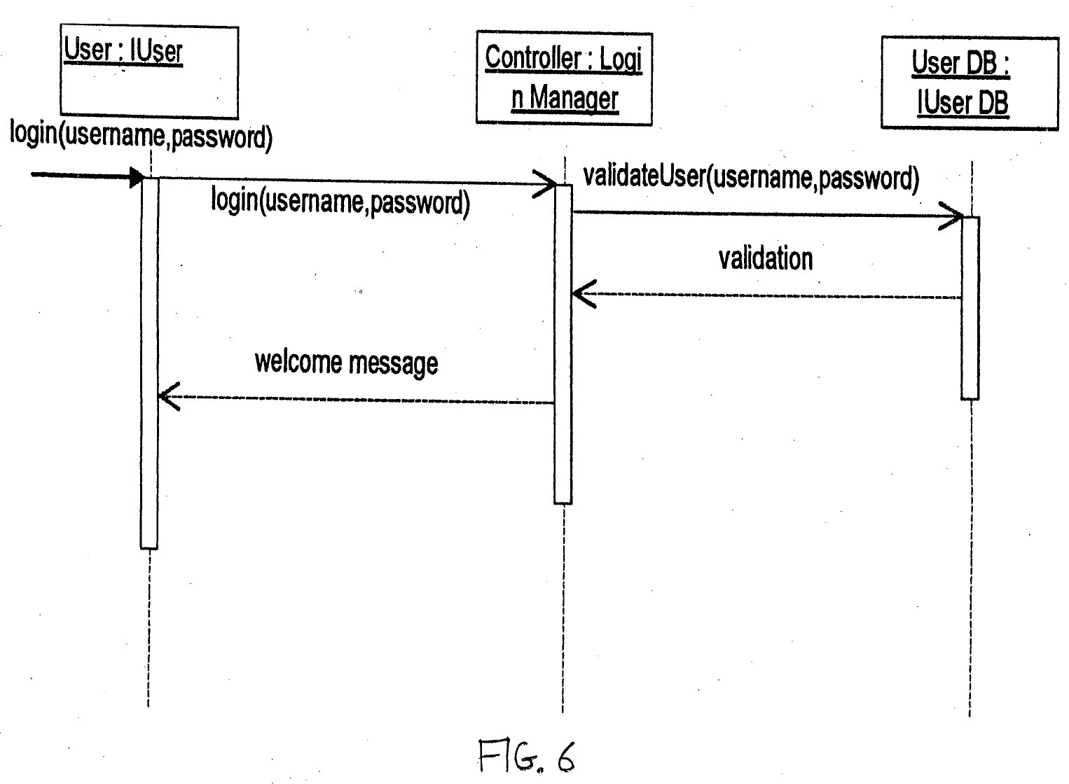

FIG. 6 shows the operation of the authorisation system to authorise a user.

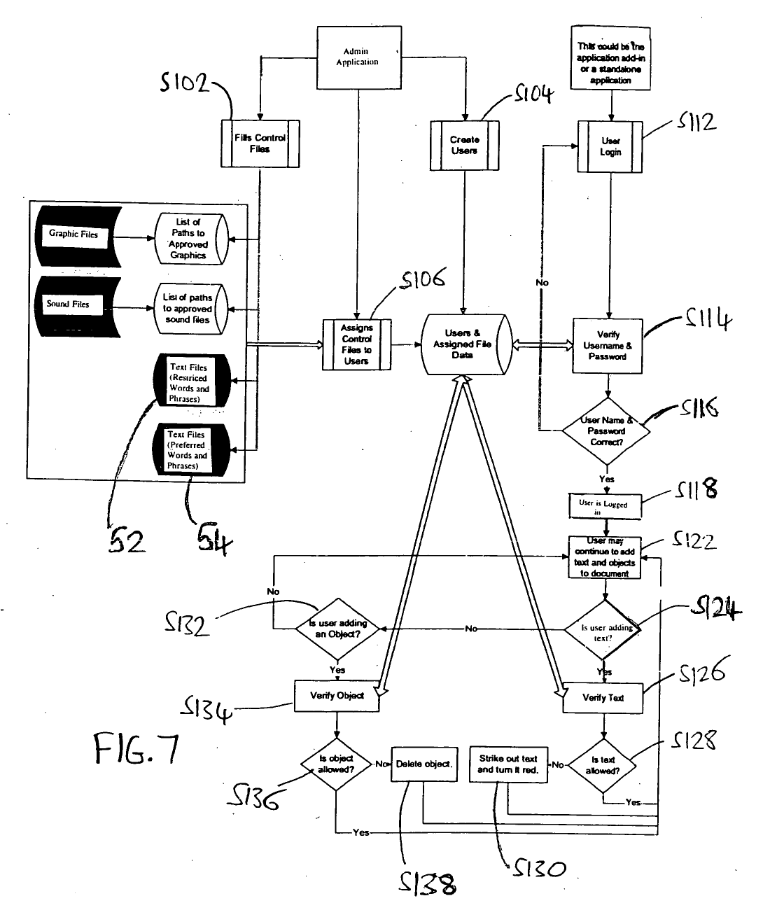

FIG. 7 is a flow diagram showing the overall operation of an embodiment of the invention.

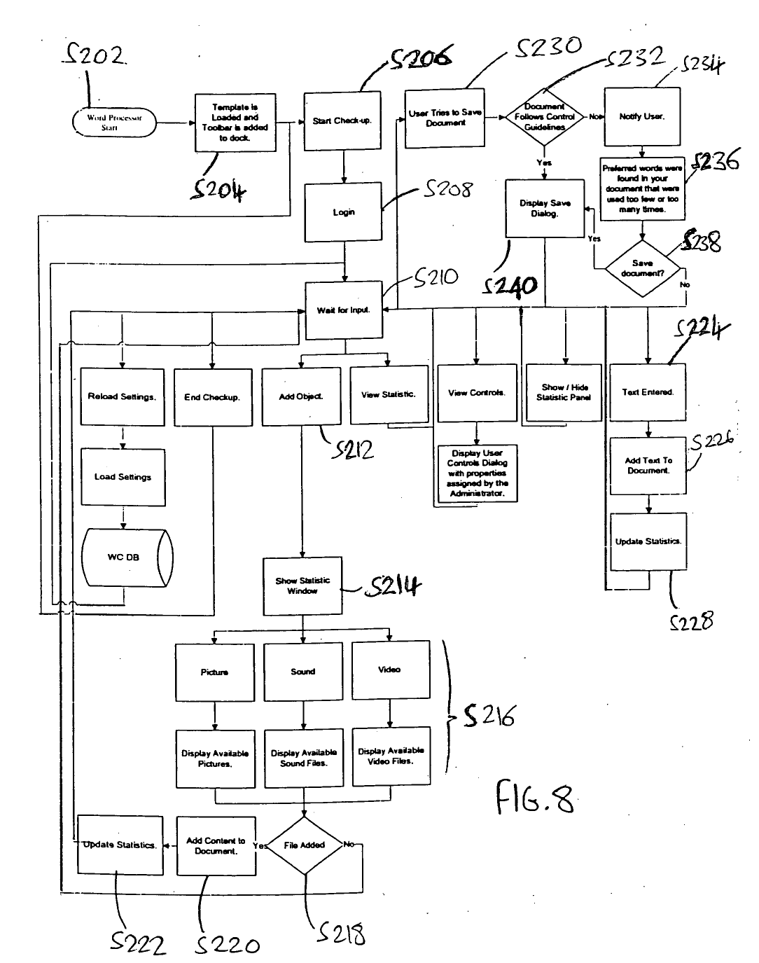

FIG. 8 is a flow diagram showing the operation of a document control system according to an embodiment of the invention in conjunction with a word processor.

With reference to FIGS. 1 and 2, in one embodiment of the invention the editing system 10 consists of an authorisation system 20, an administration system 30 and a document control system 40. These systems are preferably implemented as modules in a program running on a computer equipped with a keyboard, a storage device and a display.

The operation of the authorisation system to authorise an administrator and a user is described with reference to FIGS. 5 and 6 respectively. The authorisation system 20 operates to ensure that only authorised persons have access to the system, and divides the authorised persons into two groups, namely administrators and users. The authorisation system 20 comprises a login manager 22, an administrator identification file 24 and a user identification file 26.

The login manager 22 is activated every time the editing system 10 is run. The login manager 22 allows the operator to input a login name and password, and searches the administrator identification file 24 and the user identification file 26 using the entered login name and password. If the login manager 22 determines that the entered login name and password match an entry in the administrator file 24, then control is passed to the administration system 30. Alternatively, the operator may be given the option of selecting either the administration system 30 or the document control system 40, and control is then passed to the chosen system. If the login manager 22 determines that the entered login name and password match an entry in the user file 26, then control is passed to the document control system 40. Finally, if the entered login name and password do not match an entry in either file, then the login manager 22 notifies the operator that the entered login name and password are incorrect and allows the operator to input a further login name and password.

Hence only authorised operators can use either the administration system 30 or the document control system 40. Whether a given operator can use the administration system 30 depends on whether their login name and password is stored in the administrator identification file 24. Operators are effectively divided into administrators, who can use both the administration system 30 and the document control system 40, and users, who can only use the document control system 40.

The administration system 30 comprises an administration manager 32, a search manager 34 and one or more helper applications 36.

The operation of the administration system to fill the control and configuration files is described with reference to FIG. 3. When the login manager 22 passes control to the administration system 30, the administration manager 32 allows the operator to input a search command, amongst other commands. In response to the search command, the administration system 30 activates the search manager 34. The search manager 34 allows the operator to enter one or more search terms. These search terms are then supplied to the helper applications 36 by the search manager 34. The helper applications 36 are applications capable of retrieving appropriate information from data resources on the basis of search terms. Possible helper applications 36 include web browsers, Internet search engines, search agents, web-based lexical services, and applications used to catalogue archives of text, photographs, video or audio.

In response to receiving the search terms, each helper application 36 returns data selectively obtained from a data resource. For example, a web search engine operating as a helper application 36 would return data from web sites related to the search terms. In addition, the administration system 30 is capable of receiving data via email, File Transfer Protocol (FTP) and Secure File Transfer Protocol (SFTP). The administration system 30 processes the raw data returned by the helper applications 36 to produce control data and configuration data. The control data is used to fill control files 50 and the configuration data is used to fill configuration files 60.

In this embodiment, the control files 50 act as an exhaustive dictionary of content that is allowed to be used in a document, as discussed below in relation to the document control system 40. The processing performed by the administration system 30 extracts words, images etc. from the data provided by the helper applications 36 and then stores this content in the control files 50, allowing content determined to be relevant to the search terms input by the administrator to be used in future documents. The system also allows the administrator to edit the control files 50 to remove any content returned by the helper applications 36 that is deemed inappropriate.

Each configuration file 60 contains a set of rules with which the content of a document being edited is required to comply, as discussed further below. The rules stored in the configuration files 60 may either be produced automatically by the administration system 30 on the basis of the data provided by the helper applications 36 or be entered manually by the administrator. In one embodiment the administration system 30 determines rules exhibited in text and objects obtained from the World Wide Web by a helper application 36 and stores those rules as configuration data. The set of rules may include rules of grammar and syntax and various application specific rules. For example, a configuration file 60 could specify that a certain phrase may only be used once every two hundred words and must always be prefaced by a particular logo.

The administration system 30 includes a rule entry system which allows an administrator to enter rules manually. The system is capable of receiving and storing rules involving complex relationships between document data, the content of the control files 50 and external resources such as Internet-based data objects. In addition, the administration system 30 is capable of learning from the structure of the data returned from its searches in the context of the currently selected rules and control files 50 to improve the relevance of the data output by the administration system 30 and to suggest further rules to the administrator.

For example two words, A and B, are common individually. However, when used together they form a phrase which is contained within a current control file 50 and the use of which is regulated by the rule set in a configuration file 60. If a search performed by the administration system 30 finds that this phrase is always used together with a third word, C, then the administration system 30 will suggest the determined relationship between A, B and C to the administrator via any preferred means of communication, for example email. If the administrator decides that this relationship is necessary, it is added to the rule set contained in a configuration file 60. Furthermore, the administration system 30 automatically organises and simplifies the set of rules whenever the set of rules is modified, specifically by removing duplicated rules and by arranging the set of rules into a hierarchy comprising subsets and supersets. The hierarchy of rules is displayed graphically to allow the administrator to modify the rules efficiently.

The document control system 40 comprises a write manager 42 and a document store 44. When the login manager 22 passes control to the document control system 40 the write manager 42 is activated and the user is allowed to begin creating or editing a document. In this embodiment the write manager 42 operates in conjunction with a word processor program, and the following description assumes that the write manager 42 controls the use of various functions of the word processor program to thereby control the editing of a document.

However, this is not the only use of the present invention, and in other embodiments the write manager 42 may, for example, control the editing of a video clip in a video editing package or control the editing of a sound file in an audio editing system built in to the write manager 42. The present invention is applicable to controlling any system for editing a document of any kind.

The operation of the document control system to control the editing of a document is described with reference to FIG. 4. The document control system 40 compares each new or modified data object in the document with the contents of the control files 50 and the set of rules in the configuration files 60, either continuously as the user inputs and edits the content of the document or in response to a predetermined event. If a data object is found either not to be present in the control files 50 or to violate one of the rules contained in the configuration files 60, then that data object is determined not to be allowable and the document control system 40 intervenes in the editing of the document.

The action taken by the document control system 40 in response to detecting a non-allowable data object will depend on the particular purpose for which the editing system 10 is being used. In a preferred embodiment the document control system 40 checks the contents of the document being edited continuously, and notifies the user immediately if the document contains data objects which are not contained in the control files 50, or if the content of the document violates any of the rules in the configuration files 60. For example, the document control system 40 may strike through or highlight non-allowable data objects in the document.

Alternatively, the document control system 40 may not allow any non-allowable content to be inserted into the document, and may automatically delete any such content that the user attempts to insert. The document control system 40 may substitute an appropriate allowable alternative for any non-allowable data object that the user attempts to insert into the document, or may merely suggest such an alternative.

In one embodiment, the document control system 40 does not allow the user to save the document unless all of the content of the document is allowable. In this embodiment, the document control system 40 may only check the contents of the document when a request is made to save the document.

The document control system 40 can also suggest or require that additional content is inserted on the basis of the existing content of the document and the control and configuration files. For example, a configuration file may contain a rule specifying that whenever a particular trade name is used, it must be preceded by a corresponding logo. The document control system 40 would then intervene in the editing of the document in one or more of the ways discussed above to ensure that the logo is added to the document before every instance of the trade name.

In addition to controlling the content of a document, the document control system 40 provides statistics relating to the edited document to the user during editing. In a preferred embodiment, the document control system 40 displays and stores statistics including the frequency of use of a given data object, the period of use of the given data object (i.e. the number of other data objects between one use of the given data object and the next), the popularity of the given data object within selected external sources (e.g. web sites), the page-ranking of the given data object in the terms of a search engine, and the link reputation of the given data object in the terms of a search engine. The document control system 40 may also display any rules associated with the statistics together with the statistics. The display of such statistics in real-time during editing encourages the user to use the available data objects in the most effective way. The administration system 30 includes a tool for searching the web, locating relevant sources of information, analysing the data and reporting the results in real-time to the user.

The following is an example of the use of an embodiment of the invention, described with reference to FIG. 7. In the embodiments shown in FIG. 7 configuration files are used as described above, and accordingly the use of configuration files is not discussed in detail in the following.

The system is initiated, activating the authorisation system 20 and the login manager 22. An administrator of the editing system 10 then enters a login name and password, in response to which the login manager 22 refers the login name and password as search terms to both the user identification file 26 and the administrator identification file 24. Provided that the login name and password form a correct administrator login, the administrator identification file 24 will report back to the login manager 22 that the login has been validated. Upon receiving the validation report, the login manager 22 passes control to the administration system 30.

The administration system search manager 34 allows the administrator to enter search terms for use by selected helper applications 36 to fill control files 50 including graphic files, sound files and text files at step S102. The administration system 30 also allows the administrator to create users at step S104, i.e. login names recognised as authorised users, each login name having associated data such as a password and particular control and configuration files. In this embodiment, each user is assigned a particular set of control files 50 and configuration files 60 at step S106, the set of assigned control files 50 and configuration files 60 differing between users. Another feature of this embodiment is that the set of control files 50 contains a set of restricted text files 52 containing restricted words and phrases. Whereas in other embodiments the control files 50 contain an exhaustive dictionary of allowed data objects including text, in this case all text is allowed except for text contained within the restricted text files 52. The control files 50 also contain a set of preferred text files 54 containing preferred words and phrases. The edited document is subject to predetermined rules regarding the text contained within the preferred text files 54. For example, the system may impose a minimum frequency of use for words contained within the preferred text files 54.

In other embodiments, one set of control files 50 acts as an exhaustive dictionary of allowed data objects and another set of control files 50 defines restricted and preferred combinations within those allowed data objects. For example, a set of words may all be contained in the exhaustive dictionary individually, but may be restricted when combined to form a particular phrase.

Having filled the control files 50 and the configuration files 60, the administrator logs out of the system. A user logs in to the system by entering a login name and password at step S112 which the user identification file 26 validates at step S114. If the login name and password are found to be correct at decision point S116 then the user is logged in at step S118. Otherwise the system returns to step S112. After the user is logged in the login manager 22 passes control to the document control system 40. The document control system 40 in this example controls the use of a word processing system such as any popular word processing software. The word processor may be activated either before or after the editing system 10 in a multi-tasking operating system.

When the user starts editing a document in the word processor at step S122, the system responds differently depending on whether the user is adding an object or adding text. If the user is adding text at decision point S124, then the document control system 40 checks the text against the content of the control files 50 assigned to the user at step S126. Similarly, whenever a data object is being added at decision point S132 it is verified at step S134. In this embodiment, the content of the document is divided into text and other data objects, e.g. graphics and sounds. If a data object, i.e. data other than text, is determined not to correspond to any of the approved graphic and sound files at decision point S136 then the system deletes that data object at step S138. If a piece of text is determined to be contained in the restricted text files 52 at decision point S128 then that piece of text is struck out and coloured red at step S130.

Although the control files 50 and configuration files 60 perform different functions and have been treated as separate entities, in practice both sets of files may be stored in the same storage device. Furthermore, every control file and configuration file may form part of the same library file.

The operation of the document control system 40 of another embodiment of the invention is shown in FIG. 8. The features of the remaining parts of the editing system of this embodiment are as described above.

First the word processing software is started at step S202, following which the editing system software is started at step S204. The editing system software features a template and a toolbar which are integrated into the word processing software. When the editing system software starts, a check-up routine is performed at step S206, the authorisation system 20 is activated and the user logs in at step S208. Control then passes to the document control system 40 and the user may begin editing a document in the word processor. The document control system 40 awaits input from the user at step S210 and responds accordingly. Of particular relevance to the present invention are the system responses to the user making a request to add an object to the document (steps S212 to S222), entering text (steps S224 to S228), and saving the document (steps S230 to S240).

When the user makes a request to add a data object to the document at step S212, the system first shows a statistics window displaying statistics related to the document to the user at step S214, as discussed above. The statistics are stored in a statistics file. The system then presents a menu of available media files as data objects to the user at step S216. The user may select one of these files to be added at decision point S218, in response to which the document control system 40 adds a data object stored in the file to the document at step S220, updates the statistics file at step S222 and returns to await further input at step S210. When the user enters text at step S224, the system simply adds the text to the document at step S226 and updates the statistics file at step S228.

When the user requests that the document is saved at step S230, the document control system 40 checks the content of the document against the relevant control and configuration files 50, 60 to determine whether the content of the document is allowable. The respective functions of the control and configuration files 50, 60 are as in any of the embodiments discussed above. If the content of the document is determined to be allowable at decision point S232, then a save dialog box is displayed at step S240 and the document can be saved. If content is determined not to be allowable at decision point S232, then the user is notified at step S234 and a description of the problem is displayed at step S236. For example, the system may display a message indicating that certain preferred words, i.e. words contained in a preferred text control file 54 as described above, are used too infrequently. After the user has been notified, the document control system 40 allows the user to save the document or to cancel the saving operation at decision point S238. In a modification of this embodiment, the document control system 40 does not allow the user to save the document unless the content of the document is determined to be allowable.

The display of statistics in this embodiment assists the user in creating an effective document. For example, displaying the frequency of use of a particular word allows the user to determine whether that word appears too often in the document and to use an alternative word if necessary.

One example of a task for which the present invention can be used is creating an advertisement. In advertising, the use of certain combinations of words in a document is likely to lead to a successful advertisement, whereas the use of other combinations is not. In other words, a set of rules relating to the content of a document can be determined that will improve the effectiveness of the resulting advertisement if followed. The editing system according to the present invention as described above allows appropriate rules to be determined and stored either manually or automatically based on data obtained from a data resource such as the web. For example, an administrator could instruct the system to perform a search for particular terms related to the relevant field of advertising in advertisements on web sites. Based on the data retrieved, the editing system could then create rules restricting the use of the most common phrases in relevant existing web site advertisements. The stored rules are implemented by the editing system as a user edits an advert, by notifying the user that a specific part of the advertisement does not comply with the rules for example.

As a further example, the present invention could assist in producing promotional films for a political party. An administrator of the system could instruct the system to search a database for video clips and sound files relating to a particular politician. The administrator could then manually create rules specifying that only particular video clips showing the politician are to be used and restricting the use of certain video clips and sound files in close proximity to each other within a film. The rules created would be applied to any film subsequently edited by a user of the system. As a result, the editing system would allow the administrator to reduce the chance of any promotional film produced containing inappropriate content or creating an undesirable impression.

In the preferred embodiment, the editing system 10 is implemented as add-in software for a popular word processor such as Microsoft Word™ and runs on a PC under an operating system such as Microsoft Windows XP™. The PC on which the editing system 10 runs is preferably connected to the Internet and/or an intranet to provide the external data resources and helper applications 36 required by the administration system 30. The user interface of the editing system 10 is graphical and the system is capable of using any common format for data transfer from internet and local area network (LAN) sources, including email, FTP, SFTP, HTML and others.

However, other arrangements are possible and the invention may be implemented entirely in hardware, entirely in software or in a mixture of hardware and software. The above files and other data may be stored in any memory or storage device, including a ROM, a RAM, a hard disc drive or any combination of devices. A computer program according to the invention may be adapted to run on any hardware which allows a document to be edited.

The aforegoing description has been given by way of example only and it will be appreciated by a person skilled in the art that modifications can be made without departing from the scope of the present invention.

1. An editing system comprising:
a control file store for storing control file data;
a control file manager capable of selectively obtaining content data from a data resource in response to a search term input by a user, generating control file data on the basis of the obtained content data and storing the control file data in the control file store;
a document verifier capable of receiving document data forming part of a document edited by a user and outputting a control signal based on the document data and part or all of the control file data; and
a document controller capable of receiving control signals from the document verifier and performing a predetermined action at least in response to receiving a rejection control signal.

2. An editing system according to claim 1, further comprising:
a configuration file store for storing configuration file data; and
a rule manager capable of receiving commands input by a user, the commands defining one or more rules for use of the control file data, and further capable of generating configuration file data defining the rules in response to the commands and storing the configuration file data in the configuration file store;
wherein the document verifier is capable of outputting the control signal based on the document data, part or all of the control file data and part or all of the configuration file data.

3. An editing system according to claim 2, wherein the document verifier outputs an acceptance control signal if the document data is contained in the control file data and complies with the rules contained in the configuration file data.

4. An editing system according to claim 3, wherein the document verifier outputs the rejection control signal if the document data is not contained in the control file data and also outputs the rejection control signal if the document data does not comply with a rule contained in the configuration file data.

5. An editing system according to claim 2, wherein the content data comprises a plurality of content data objects and the rule manager is capable of determining an association between two or more of the plurality of content data objects on the basis of the relative arrangement of the content data objects within the content data; and
wherein the rule manager is capable of generating a deduced rule defining the determined association, generating deduced configuration file data defining the deduced rule and storing the deduced configuration file data in the configuration file store.

6. An editing system according to claim 2, further comprising an authoriser for authorising a user upon activation of the editing system, wherein the authoriser is capable of requesting login data to be input by a user;
wherein if the login data input by the user is contained within a first file then the authoriser allows the user to operate at least one of the control file manager and the rule manager;
wherein if the login data input by the user is contained within a second file then the authoriser allows the user to operate the document verifier and the document controller and does not allow the user to operate the control file manager or the rule manager; and
wherein if the login data input by the user is not contained within the first file and is not contained within the second file then the authoriser does not allow the user to operate any of the control file manager, the rule manager, the document verifier and the document controller.

7. An editing system according to claim 2, further comprising a file assignor capable of assigning a subset of the control file data to a user and further capable of assigning a subset of the configuration file data to the user;
wherein when the document verifier receives document data forming part of a document edited by the user, the document verifier outputs the control signal based on the document data, the subset of the control file data and the subset of the configuration file data.

8. An editing system according to claim 1, further comprising a document store capable of storing the document data;
wherein the document controller comprises a storage controller for preventing storage of the document data in the document store in response to the rejection control signal.

9. An editing system according to claim 1, wherein the document controller comprises a user informer for notifying the user that the document data has been rejected in response to the rejection control signal.

10. An editing system according to claim 1, wherein the document controller comprises a document data replacer for deleting the document data and replacing it with alternative document data in response to the rejection control signal.

11. An editing system according to claim 1, further comprising a statistics display for displaying statistics related to the document data to the user, the statistics being updated during editing.

12. An editing system according to claim 1, wherein the control file manager further comprises a communicator for outputting the search term to a helper application via a network and receiving information from the helper application via the network, wherein the helper application is capable of retrieving selected information from the data resource in response to the search term and outputting the selected information to the communicator via the network.

13. A method for controlling an editing system, the method comprising:
selectively obtaining content data from a data resource in response to a search term input by a user, generating control file data on the basis of the obtained content data and storing the control file data in a control file store;
receiving commands input by a user, the commands defining one or more rules for use of the control file data, generating configuration file data defining the rules in response to the commands and storing the configuration file data in a configuration file store;
receiving document data forming part of a document edited by a user and determining whether the document data is allowable based on the document data, part or all of the control file data and part or all of the configuration file data; and
performing a predetermined action if the document data is determined not to be allowable.

14. A computer program product capable of performing a method for controlling an editing system, the method comprising:
selectively obtaining content data from a data resource in response to a search term input by a user, generating control file data on the basis of the obtained content data and storing the control file data in a control file store;
receiving commands input by a user, the commands defining one or more rules for use of the control file data, generating configuration file data defining the rules in response to the commands and storing the configuration file data in a configuration file store;
receiving document data forming part of a document edited by a user and determining whether the document data is allowable based on the document data, part or all of the control file data and part or all of the configuration file data; and
performing a predetermined action if the document data is determined not to be allowable.

15. An editing system comprising:
a control file store for storing control file data including one or more data objects;
a configuration file store for storing configuration file data defining one or more rules;
a document verifier capable of receiving document data including one or more document data objects forming part of a document edited by a user and outputting a control signal based on whether the document data objects are included in the control file data and whether the document data complies with the rules defined in the configuration file data;
a document store for storing the document; and
a document controller capable of receiving the control signal and preventing the document from being stored in the document store in response to receiving a rejection control signal.
